(19) United States
(12) Patent Application Publication
(10) Pub. No.: US 2026/0235255 A1
(43) Pub. Date: Aug. 13, 2026

(54) TANK AND ROTATING ELECTRIC MACHINE SYSTEM

(71) Applicant: HONDA MOTOR CO., LTD., Tokyo (JP)

(72) Inventors: Yuki Wada, Wako-shi (JP); Daijiro Eto, Wako-shi (JP); Motoshi Togasaki, Wako-shi (JP); Kenta Yamazaki, Wako-shi (JP); Keita Chinzaka, Wako-shi (JP); Rintaro Tanaka, Wako-shi (JP)

(21) Appl. No.: 19/531,138

(22) Filed: Feb. 5, 2026

(30) Foreign Application Priority Data
Feb. 12, 2025 (JP) 2025-020438

(51) Int. Cl. F16N 39/00; B01D 19/00; F16N 19/00; H02K 7/08

(52) U.S. Cl. CPC F16N 39/002; B01D 19/0042; F16N 19/00; H02K 7/08; F16N 2210/14; F16N 2210/18

(57) ABSTRACT

A tank includes a storage unit that is capable of storing a liquid, a first inlet, which is an inlet for a first fluid containing the liquid, and which communicates with the storage unit, a second inlet, which is an inlet for a second fluid containing a gas and a liquid, which communicates with the storage unit, and which is disposed at a position higher than the storage unit, a liquid discharge port that discharges the liquid from the storage unit, and a gas discharge port that discharges the gas that was separated from the second fluid.

### CROSS-REFERENCE TO RELATED APPLICATIONS

This application is based upon and claims the benefit of priority from Japanese Patent Application No. 2025-020438 filed on Feb. 12, 2025, the contents of which are incorporated herein by reference.

### BACKGROUND OF THE INVENTION

### FIELD OF THE INVENTION

The present disclosure relates to a tank and a rotating electric machine system.

### DESCRIPTION OF THE RELATED ART

For example, in JP 2020-091001 A, a configuration for supplying a lubricating oil to a rotating structure is disclosed. Further, in JP 2022-175731 A, a tank for storing a lubricating oil is disclosed.

### SUMMARY OF THE INVENTION

In order to recover the lubricating oil supplied to an object to be lubricated and supply the lubricating oil again to the object to be lubricated, it is desirable to efficiently recover the lubricating oil in a tank. Furthermore, in the case that a gas-liquid mixture fluid in which the lubricating oil and air are mixed is introduced into a tank, it is desirable to effectively separate the gas and the liquid from the gas-liquid mixture fluid. The same applies when the object to be collected in the tank is a liquid other than a lubricating oil.

The present invention has the object of solving the aforementioned problem.

A first aspect of the present disclosure is characterized by tank including a tank main body configured to carry out gas-liquid separation, the tank including a storage unit disposed in the tank main body, and configured to store a liquid, a first inlet, which is an inlet for a first fluid containing the liquid, configured to communicate with the storage unit, a second inlet, which is an inlet for a second fluid containing a gas and the liquid, configured to communicate with the storage unit, and disposed at a position higher than the storage unit, a liquid discharge port configured to discharge the liquid from the storage unit, and a gas discharge port configured to discharge the gas that was separated from the second fluid.

A second aspect of the present disclosure is characterized by a rotating electric machine system, including a rotating electric machine housing configured to rotatably support a rotating shaft via a bearing, an oil circulation supply device configured to supply a lubricating oil to the rotating electric machine housing in order to lubricate the bearing, and to recover the lubricating oil from the rotating electric machine housing, wherein the oil circulation supply device is equipped with a tank including a tank main body configured to carry out gas-liquid separation, the tank including a storage unit disposed in the tank main body, and configured to store the lubricating oil, a first inlet, which is an inlet for a first fluid containing the lubricating oil, configured to communicate with the storage unit, a second inlet, which is an inlet for a second fluid containing a gas and the lubricating oil, configured to communicate with the storage unit, and which is disposed at a position higher than the storage unit, a liquid discharge port configured to discharge the liquid from the storage unit, and a gas discharge port configured to discharge the gas that was separated from the second fluid.

According to the tank and the rotating electric machine system of the present disclosure, together with the liquid contained in the first fluid that flows in from the first inlet being capable of being stored in the storage unit, the liquid contained in the second fluid that flows in from the second inlet is capable of being stored in the storage unit. Further, the gas contained in the second fluid is discharged from the gas discharge port. Therefore, the gas-liquid mixture fluid that is introduced into the tank is capable of being effectively separated into a gas and a liquid.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a perspective view of a combined motive power system;

FIG. 2 is a schematic cross-sectional view of a rotating electric machine system;

FIG. 3 is a schematic cross-sectional view of the rotating electric machine system as viewed from another angle;

FIG. 4 is an enlarged cross-sectional view in the vicinity of a first bearing;

FIG. 5 is an enlarged cross-sectional view in the vicinity of a second bearing;

FIG. 6 is a conceptual diagram of an oil circulation supply device in the rotating electric machine system;

FIG. 7 is a schematic cross-sectional view of a tank;

FIG. 8 is a cross-sectional view of a liquid surface adjusting structure of the tank; and

FIG. 9 is a cross-sectional view of a tank according to an exemplary modification.

### DETAILED DESCRIPTION OF THE INVENTION

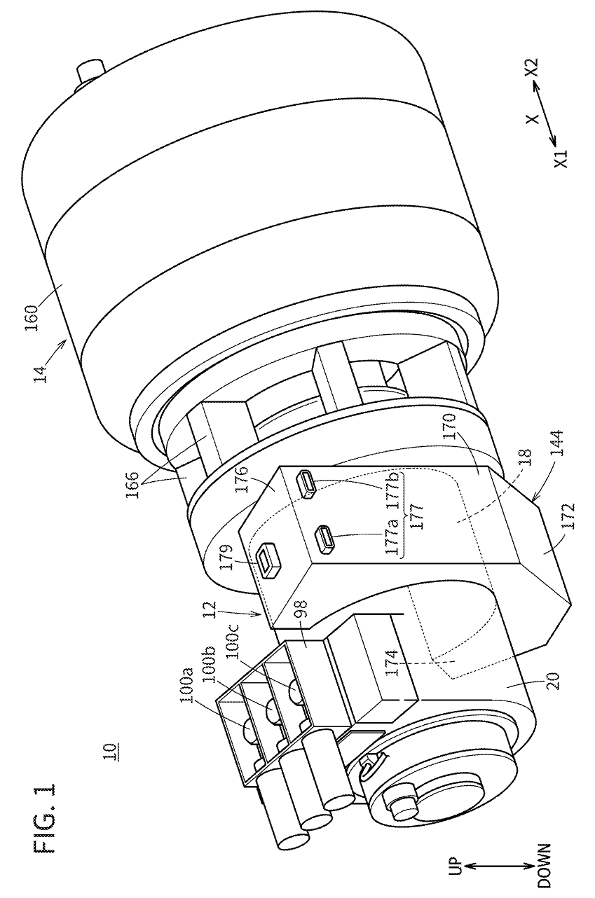

A combined motive power system 10 shown in FIG. 1 is equipped with a rotating electric machine system 12 according to the present embodiment, and a gas turbine engine 14. An axial line of the rotating electric machine system 12, and an axial line of the gas turbine engine 14 coincide with each other. Stated otherwise, the rotating electric machine system 12 and the gas turbine engine 14 are arranged in series on the same axial line.

The combined motive power system 10 is used, for example, as a motive power source for providing propulsion in a flying object, a ship, an automobile, or the like. Suitable specific examples of the flying object include drones and multi-copters. The combined motive power system 10, when mounted on a flying object, is used as a power drive source for rotationally driving, for example, a prop, a ducted fan, or the like. The combined motive power system 10, when mounted on a ship, is used as a screw rotational force generating device. The combined motive power system 10, when mounted on an automobile, is used as a power drive source for rotating a motor.

The combined motive power system 10 can also be used as an auxiliary electrical power source in an aircraft, a ship, a building, or the like. Apart therefrom, it is also possible to utilize the combined motive power system 10 as gas turbine power generation equipment. The gas turbine engine 14 is an internal combustion engine.

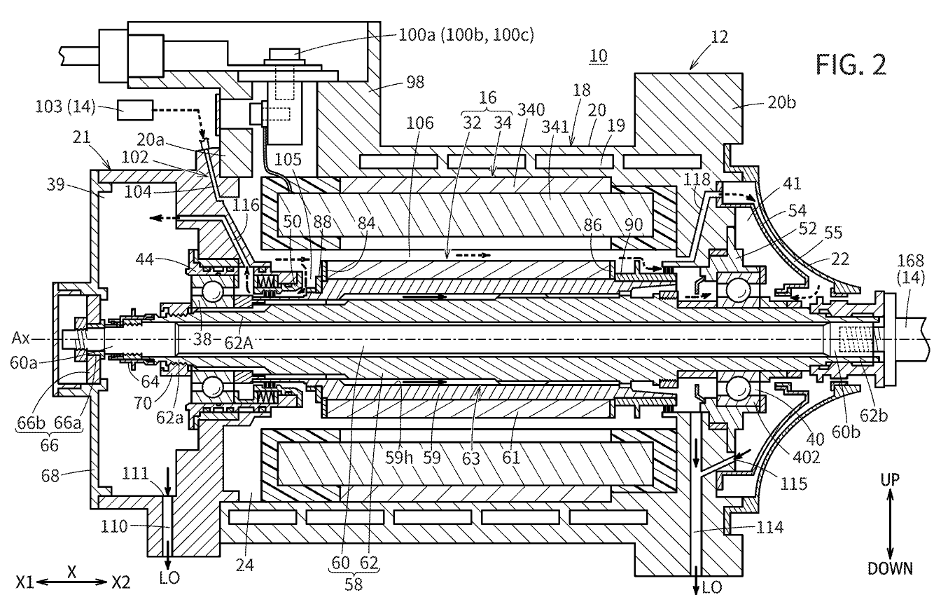

In the following description, the respective terms "lower" and "upper" refer specifically to the lower and the upper directions shown in FIG. 2.

As shown in FIG. 2, the rotating electric machine system 12 is equipped with a rotating electric machine 16, and a rotating electric machine housing 18. In the present embodiment, the rotating electric machine 16 is a generator. The rotating electric machine 16 includes a rotor 32 and a stator 34.

The rotating electric machine housing 18 accommodates the rotating electric machine 16. The rotating electric machine housing 18 includes a main housing 20, a first sub-housing 21, and a second sub-housing 22. The main housing 20 has a substantially hollow-cylindrical shape. The main housing 20 includes an accommodation chamber that serves to accommodate the rotating electric machine 16. A cooling jacket 19 is formed in the interior of a circumferential wall part of the main housing 20. A liquid coolant such as cooling water or the like flows through the cooling jacket 19.

The first sub-housing 21 is connected to a first housing end 20a, which is an end part on a side in the X1 direction of the main housing 20, and thereby closes an opening of the first housing end 20a. The second sub-housing 22 is connected to a second housing end 20b, which is an end part on a side in the X2 direction of the main housing 20, and thereby closes an opening of the second housing end 20b.

The rotor 32 is supported via a first bearing 38 and a second bearing 40 to be capable of rotating with respect to the rotating electric machine housing 18. Next, a description will be given concerning the first bearing 38, the second bearing 40, and a surrounding structure thereof.

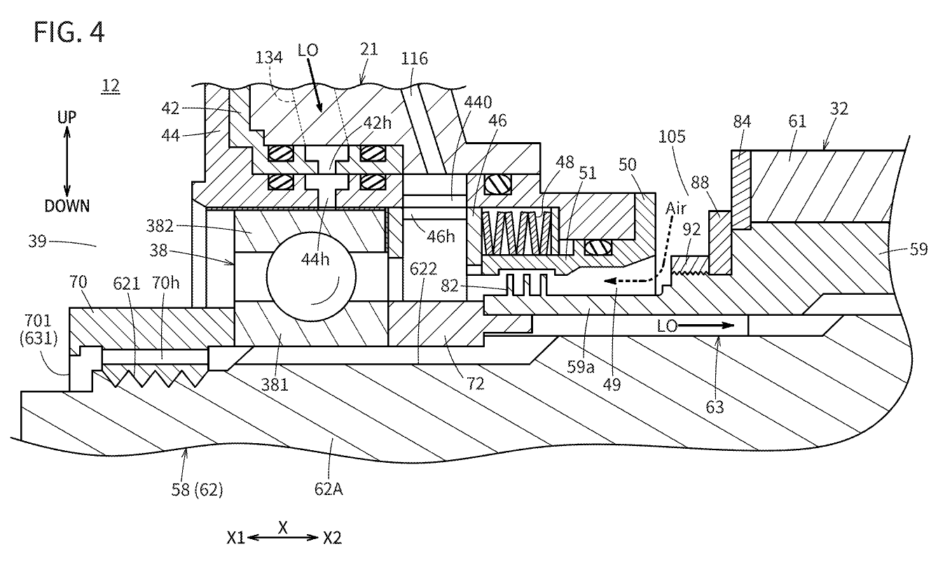

As shown in FIG. 4, a hollow cylindrically shaped holder spacer 42 and a hollow cylindrically shaped first bearing holder 44 are inserted into the inner circumferential part of the first sub-housing 21. The first bearing 38 is disposed on an inner side of the first bearing holder 44. A hollow portion of the first sub-housing 21 forms a first bearing chamber 39 in which the first bearing 38 is accommodated. A lubricating oil LO is supplied to the first bearing 38, via an oil supplying hole 42h that is formed in the holder spacer 42, and an oil supplying hole 44h that is formed in the first bearing holder 44.

The first bearing holder 44 includes a plurality of oil drainage holes 440. The plurality of oil drainage holes 440 are holes for the purpose of discharging the lubricating oil LO that was supplied to the first bearing 38 to the exterior of the first bearing holder 44.

A spacer ring 46 is fixed inside an interior of the first bearing holder 44. The spacer ring 46 includes a plurality of relay holes 46h. The plurality of relay holes 46h are formed at intervals in the circumferential direction of the spacer ring 46.

A preload applying member 48, via the spacer ring 46, applies a load (a preload) to an outer ring 382 of the first bearing 38. The direction of the load is in the axial direction (the X direction) of the rotor 32. The preload applying member 48 is constituted, for example, by a plurality of disc springs.

A holder member 50 is mounted on an end part on a side in the X2 direction of the first bearing holder 44. The holder member 50 is fixed to the first bearing holder 44, and therefore, is a non-rotating part. The holder member 50 serves to retain the preload applying member 48. The holder member 50 includes a hollow cylindrically shaped holder cylinder part 51. The preload applying member 48 is disposed in an annular space that is formed between the first bearing holder 44 and the holder cylinder part 51.

As shown in FIG. 2, an annular shaped second bearing holder 52 is mounted on the second housing end 20b (an end part on a side in the X2 direction) of the main housing 20. The second bearing holder 52 is connected via bolts or the like to the main housing 20. An outer ring 402 of the second bearing 40 is retained on an inner circumferential part of the second bearing holder 52. A flow path forming member 54 is fixed to an end part on a side in the X2 direction of the main housing 20. The flow path forming member 54 covers the second bearing 40. A hollow portion of the flow path forming member 54 forms a second bearing chamber 41 in which the second bearing 40 is accommodated.

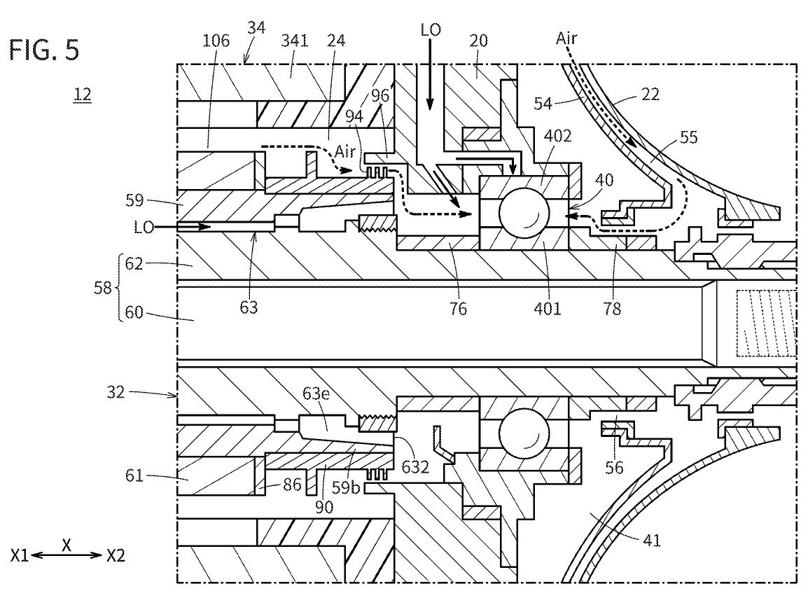

The rotor 32 includes a rotating shaft 58, a sleeve 59, and permanent magnets 61. The sleeve 59 surrounds the rotating shaft 58, and the permanent magnets 61 surround the sleeve 59. A rotor internal flow path 63 is formed in the rotor 32. According to the present embodiment, the lubricating oil LO flows as a liquid coolant through the rotor internal flow path 63. The lubricating oil LO flows through the rotor internal flow path 63 from an inlet 631 (refer to FIG. 4) toward an outlet 632 (refer to FIG. 5) of the rotor internal flow path 63. More specifically, the lubricating oil LO flows in the X2 direction through the rotor internal flow path 63. Therefore, concerning the rotor internal flow path 63, the side in the X1 direction is an upstream side, and the side in the X2 direction is a downstream side. The rotor internal flow path 63 gradually expands in diameter in a stepwise manner toward the downstream side.

The rotating shaft 58, together with being supported to be capable of rotating by the first sub-housing 21 via the first bearing 38, is supported to be capable of rotating by the main housing 20 via the second bearing 40. The rotating shaft 58 includes an inner shaft 60, and an outer shaft 62.

The inner shaft 60 includes a first inner shaft end 60a, which is an end part on a side in the X1 direction, and a second inner shaft end 60b, which is an end part on a side in the X2 direction. The outer shaft 62 includes a first outer shaft end 62a, which is an end part on a side in the X1 direction, and a second outer shaft end 62b, which is an end part on a side in the X2 direction. The inner shaft 60 is inserted into an inner part of the outer shaft 62. The inner shaft 60 is longer than the outer shaft 62.

The first inner shaft end 60a projects out in the X1 direction from the first outer shaft end 62a. The first inner shaft end 60a, by means of a fastening structure including a nut member 64 or the like, is connected to the first outer shaft end 62a.

A resolver rotor 66a is fixed to the first inner shaft end 60a. A resolver stator 66b is disposed in a manner so as to surround the resolver rotor 66a. The resolver stator 66b is retained by a resolver holder 68 that is attached to the first sub-housing 21. The resolver rotor 66a and the resolver stator 66b constitute a resolver 66.

The outer shaft 62 is a hollow cylindrical member. As shown in FIG. 4, the outer shaft 62 defines the rotor internal flow path 63 between a fastening ring 70, the first bearing 38, a support member 72, and the sleeve 59.

An inner ring 381 of the first bearing 38 is supported by a first shaft portion 62A that constitutes an end part on a side in the X1 direction of the outer shaft 62. An outer circumferential part of the first shaft portion 62A includes a male thread 621, and a plurality of flow path grooves 622.

The fastening ring 70 is screwed onto the male thread 621 of the first shaft portion 62A. The inner ring 381 of the first bearing 38 is sandwiched between the fastening ring 70 and the support member 72 in an axial direction (the X direction) of the rotor 32. The support member 72 is an inner ring stopper. In accordance with this feature, the inner ring 381 of the first bearing 38 is fixed to a predetermined location on the outer circumferential surface of the outer shaft 62.

The fastening ring 70 includes a plurality of communication holes 70h disposed mutually at intervals in the circumferential direction. The plurality of communication holes 70h penetrate in the axial direction through an inner circumferential part of the fastening ring 70. An annular opening 701 that is disposed on a side in the X1 direction of the fastening ring 70 serves as the inlet 631 of the rotor internal flow path 63. An end surface on a side in the X2 direction of the fastening ring 70 abuts against the inner ring 381 of the first bearing 38. The plurality of communication holes 70h constitute one portion of the rotor internal flow path 63.

The plurality of flow path grooves 622 are disposed more on a downstream side than the plurality of communication holes 70h that are formed in the fastening ring 70. The plurality of flow path grooves 622 are formed mutually at intervals from one another in the circumferential direction of the outer shaft 62. Each of the flow path grooves 622 is recessed inwardly in a radial direction from the outer circumferential surface of the outer shaft 62, and extends in the axial direction of the rotor 32. The plurality of flow path grooves 622 constitute one portion of the rotor internal flow path 63. The inner ring 381 of the first bearing 38 is disposed in a manner so as to surround the plurality of flow path grooves 622.

The support member 72 is an annular portion that is disposed between the inner ring 381 of the first bearing 38 and the sleeve 59. A portion of the rotor internal flow path 63 is formed between the outer shaft 62 and the support member 72. The support member 72 is fixed to the outer shaft 62, for example, by press fitting. The support member 72 is supported by an outer circumferential part of the outer shaft 62. The support member 72 is disposed in a manner so as to surround the plurality of flow path grooves 622. The support member 72 lies adjacent to the inner ring 381 of the first bearing 38, and further, supports a first sleeve end part 59a which is one end part of the sleeve 59. A portion of the rotor internal flow path 63 is formed between the outer shaft 62 and the sleeve 59.

As shown in FIG. 5, an outlet space 63e of the rotor internal flow path 63 is formed between the outer shaft 62 and a second sleeve end part 59b.

An inner side inner ring stopper 76, an inner ring 401 of the second bearing 40, and an outer side inner ring stopper 78 are supported by an outer circumferential surface of the outer shaft 62. The inner ring 401 of the second bearing 40 is sandwiched from both sides in the axial direction between the inner side inner ring stopper 76 and the outer side inner ring stopper 78. In accordance with this feature, the inner ring 401 of the second bearing 40 is fixed to a predetermined location on the outer circumferential surface of the outer shaft 62.

As shown in FIG. 2, the sleeve 59 is a hollow cylindrical member having an inner hole 59h. The rotating shaft 58 is inserted into the inner hole 59h of the sleeve 59. A major portion of the rotor internal flow path 63 is formed by the sleeve 59 and the rotating shaft 58. The sleeve 59 surrounds the rotating shaft 58.

As shown in FIG. 4, a seal portion 82 is provided on an outer circumferential part of the first sleeve end part 59a. The seal portion 82 is a labyrinth seal including a plurality of protrusions that are spaced apart from one another in the axial direction.

The holder member 50 is a hollow tubular shaped portion that is disposed outwardly in the radial direction of the first sleeve end part 59a. Therefore, the holder member 50 faces toward the seal portion 82 in the radial direction, and surrounds the seal portion 82. A gap is formed between the seal portion 82 and the holder member 50 (the holder cylinder part 51). The preload applying member 48 is disposed in a manner so as to surround the holder member 50, the seal portion 82, and the support member 72. The first sleeve end part 59a is inserted on an inner side of the holder member 50. An annular gap 49 is formed between the first sleeve end part 59a and the holder member 50.

The sleeve 59 is fixed, for example, by shrink fitting, to an outer surface of the rotating shaft 58. The permanent magnets 61 are retained in the sleeve 59. In the present aspect, the rotor 32 is a so-called SPM (surface permanent magnet) type in which the permanent magnets 61 are disposed on an outer circumferential surface of the sleeve 59. Alternatively, the rotor 32 may be a so-called IPM (interior permanent magnet) type in which the permanent magnets 61 are embedded in the sleeve 59.

As shown in FIG. 2, a first ring body 84 abuts against end surfaces of the permanent magnets 61 on a side in the X1 direction. A second ring body 86 abuts against end surfaces of the permanent magnets 61 on a side in the X2 direction. The first ring body 84, the permanent magnets 61, and the second ring body 86 are sandwiched between a pair of magnet stoppers 88 and 90 in the axial direction of the rotor 32. Hereinafter, the magnet stopper 88 on the side in the X1 direction will be referred to as a "first magnet stopper 88," and the magnet stopper 90 on the side in the X2 direction will be referred to as a "second magnet stopper 90."

The first magnet stopper 88 is fixed by a fixing ring 92 (refer to FIG. 4) that is screwed onto the sleeve 59. The second magnet stopper 90 is fixed to the second sleeve end part 59b (refer to FIG. 5). The second sleeve end part 59b is another end part in the axial direction of the sleeve 59. The first magnet stopper 88 and the second magnet stopper 90 are fixed, for example, by shrink fitting, to an outer circumferential part of the sleeve 59. In accordance with this feature, the permanent magnets 61 are fixed to the outer circumferential surface of the sleeve 59.

As shown in FIG. 5, a seal portion 94 is provided on an outer circumferential part of the second magnet stopper 90. The seal portion 94 is a labyrinth seal including a plurality of protrusions that are spaced apart from one another in the axial direction. The seal portion 94 faces in a radial direction toward an annular shaped protrusion 96 that is disposed on the main housing 20. A gap is formed between the seal portion 94 and the annular shaped protrusion 96.

The second sleeve end part 59b forms the outlet space 63e of the rotor internal flow path 63 between itself and the outer shaft 62. An inner diameter of the second sleeve end part 59b becomes larger toward the X2 direction. A downstream end of the outlet space 63e (an opening on a side in the X2 direction of the sleeve 59 ) is the outlet 632 of the rotor internal flow path 63.

As shown in FIG. 2, the stator 34 includes a stator core 340, and a plurality of electromagnetic coils 341. The stator core 340 is a tubular shaped member. The stator core 340 is constituted, for example, by laminating a plurality of ring-shaped electromagnetic steel plates in the axial direction. A plurality of slots are formed in the stator core 340. Teeth portions are formed between adjacent ones of the slots.

The plurality of electromagnetic coils 341 include a U-phase coil, a V-phase coil, and a W-phase coil. Therefore, in the case that the rotating electric machine 16 is a generator, the rotating electric machine 16 is a so-called three-phase electrical power source. Each of the plurality of electromagnetic coils 341 is constituted by winding a conductive wire around the teeth of the stator core 340.

As shown in FIG. 1, a terminal casing 98 is integrally provided on an upper surface on a side in the X1 direction of the main housing 20. As shown in FIG. 2, a U-phase terminal 100a, a V-phase terminal 100b, and a W-phase terminal 100c are accommodated inside the terminal casing 98. The U-phase terminal 100a, the V-phase terminal 100b, and the W-phase terminal 100c are electrically connected respectively to the U-phase coil, the V-phase coil, and the W-phase coil of the stator 34.

As shown in FIG. 2, a gaseous coolant flow path structure 102 is provided in the rotating electric machine system 12. The gaseous coolant flow path structure 102 is a structure for the purpose of circulating a gas via the rotor 32 (particularly, the permanent magnets 61) and the stator 34. At a time during flowing of the gas, the rotor 32 and the stator 34 can be cooled by the cooling gas. In the following description, air will be illustrated as an example of the cooling gas. The air is supplied from a gas supply device 103. Moreover, as will be discussed later, the air that is supplied to the rotating electric machine housing 18 forms an air curtain in order to prevent the lubricating oil LO from entering an accommodation chamber 24. Therefore, the gaseous coolant flow path structure 102 also serves in a dual manner as a sealing air flow path structure.

The gaseous coolant flow path structure 102 includes a gas supply path 104, a first branching path 105, and a second branching path 106. An air supply port, which serves as an inlet of the gas supply path 104, is disposed on the outer surface of the first sub-housing 21. The first branching path 105 and the second branching path 106 are one portion of the accommodation chamber 24 of the rotor 32.

The gas supply path 104 is formed in the first sub-housing 21. The air that has passed through the gas supply path 104 flows into the accommodation chamber 24 of the main housing 20. The air that has flowed into the accommodation chamber 24 is divided into the first branching path 105 and the second branching path 106.

The first branching path 105 is a flow path that directs the air toward the first bearing 38. As shown in FIG. 4, the air that has passed through the first branching path 105 flows into the annular gap 49 that is formed between the holder member 50 and the sleeve 59, and flows in the X1 direction through this annular gap 49. In this manner, the air that flows toward the first bearing 38 forms an air curtain. The air curtain prevents the lubricating oil LO from entering the accommodation chamber 24 in which the rotor 32 is accommodated. Thereafter, via the relay holes 46h that are provided in the spacer ring 46, the air flows into a flow path 116 that is formed in the first sub-housing 21. As shown in FIG. 2, the air that has passed through the flow path 116 flows into the first bearing chamber 39 which is a hollow portion of the first sub-housing 21.

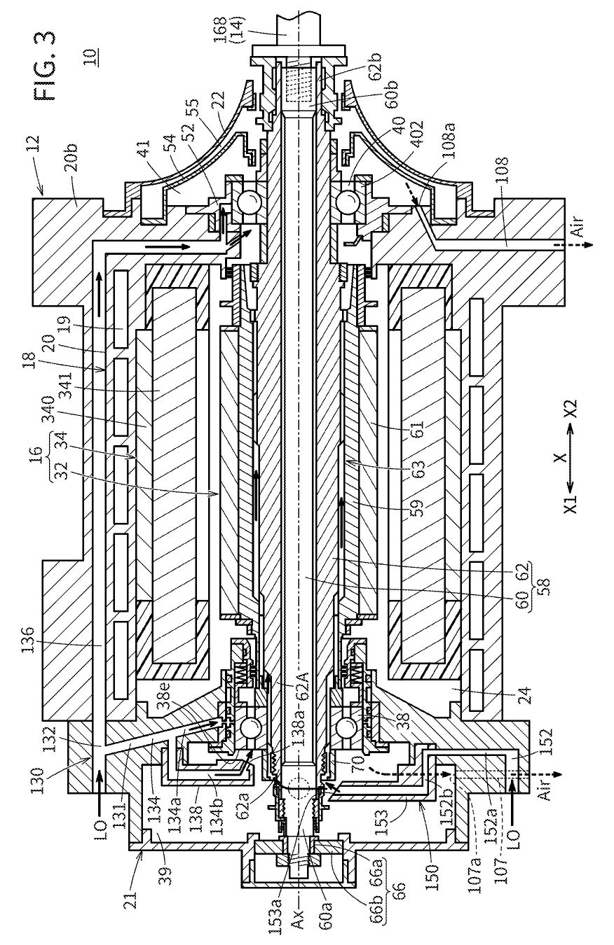

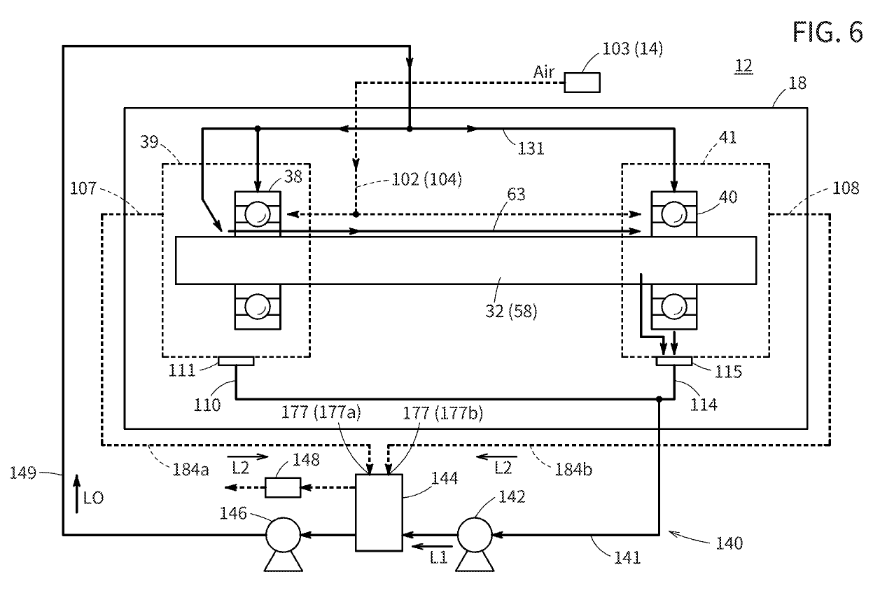

As shown in FIG. 3, the air is discharged, via a gas discharge path 107 (hereinafter referred to as a "first gas discharge path 107"), from the first bearing chamber 39. The first gas discharge path 107 is formed in the first sub-housing 21. A gas inlet (a first vent opening 107a) of the first gas discharge path 107 is formed in an upper part of the first bearing chamber 39. Moreover, concerning the term "upper part" of the first bearing chamber 39, the term signifies a region within the first bearing chamber 39 that is more upward than the axis of rotation Ax of the rotating electric machine system 12. Accordingly, the first vent opening 107a may be formed more downward than an uppermost part of the first bearing chamber 39. The air that is discharged via the first gas discharge path 107 is introduced into a tank 144 (refer to FIG. 6).

In FIG. 2, the second branching path 106 is a clearance that extends along the axial direction of the rotor 32 between the rotor 32 and the stator 34. The second branching path 106 is a flow path that directs the air toward the second bearing 40. As shown in FIG. 5, a portion of the air that has passed through the second branching path 106 flows into a side on the outer circumference of the inner side inner ring stopper 76, and flows toward the second bearing 40. In this manner, the air that flows toward the second bearing 40 forms an air curtain. The air curtain prevents the lubricating oil LO from entering the accommodation chamber 24 in which the rotor 32 is accommodated.

As shown in FIG. 2, the remainder of the air that has passed through the second branching path 106 flows into an air distribution path 118 that is formed in the main housing 20. The air that has passed through the air distribution path 118 flows into a flow path 55 that is formed between the second sub-housing 22 and the flow path forming member 54. An outer circumferential part of the flow path forming member 54 is fixed to the main housing 20 on an inner side of the second sub-housing 22. As shown in FIG. 5, an annular shaped ventilation path 56 is formed between an inner circumferential part of the flow path forming member 54 and an outer circumferential part of the outer side inner ring stopper 78. The air that has passed through the flow path 55 flows, via the flow path 55 and the ventilation path 56, into the second bearing chamber 41, and heads toward the second bearing 40.

As shown in FIG. 3, the air is discharged, via a gas discharge path 108 (hereinafter referred to as a "second gas discharge path 108") that is formed in the rotating electric machine housing 18, from the second bearing chamber 41. The gas inlet (a second vent opening 108a) of the second gas discharge path 108 is formed in an upper part of the second bearing chamber 41. Moreover, concerning the term "upper part" of the second bearing chamber 41, the term signifies a region of the second bearing chamber 41 that is more upward than the axis of rotation Ax of the rotating electric machine system 12. Accordingly, the second vent opening 108a may be formed more downward than an uppermost part of the second bearing chamber 41. The air that is discharged via the second gas discharge path 108 is introduced into the tank 144 (refer to FIG. 6).

As shown in FIG. 3, a lubricating oil flow path structure 130, and a rotor cooling structure 150 are further provided in the rotating electric machine system 12. The lubricating oil flow path structure 130 is a flow path in order to supply the lubricating oil LO to the first bearing 38 and the second bearing 40.

The lubricating oil flow path structure 130 includes a lubricating oil introduction path 132, a first distribution path 134, a first drain path 110, a second distribution path 136, and a second drain path 114. The lubricating oil introduction path 132, the first distribution path 134, and the second distribution path 136 make up an oil supply path 131 that is disposed in the rotating electric machine housing 18. The lubricating oil LO is supplied from an oil circulation supply device 140 (FIG. 6) to the lubricating oil introduction path 132. The lubricating oil introduction path 132, in the interior of the first sub-housing 21, branches into the first distribution path 134 and the second distribution path 136.

The first distribution path 134 is formed in the first sub-housing 21. The lubricating oil LO is supplied via the first distribution path 134 to the first bearing 38. The first distribution path 134 includes a first line 134a and a second line 134b. The first line 134a is a flow path that supplies the lubricating oil LO toward an outer circumferential part of the first bearing 38. The second line 134b is a flow path that supplies the lubricating oil LO toward an end surface 38e on a side in the X1 direction of the first bearing 38.

The second line 134b is formed in a first oil nozzle 138. The first oil nozzle 138 is fixed to the first sub-housing 21, and is disposed within the first bearing chamber 39. One end part of the first oil nozzle 138 is fixed to the first sub-housing 21. The first oil nozzle 138 extends toward the rotor 32. A first ejection port 138a that ejects the lubricating oil LO toward the end surface 38e of the first bearing 38 is disposed on another end of the first oil nozzle 138. The first ejection port 138a, in the vicinity of the end surface 38e of the first bearing 38, faces toward the end surface 38e.

As shown in FIG. 2, the lubricating oil LO that is supplied to the first bearing 38 is discharged from the first bearing chamber 39 via the first drain path 110 that is formed in the rotating electric machine housing 18. An upstream end of the first drain path 110 is an oil discharge port 111 (hereinafter referred to as a "first oil discharge port 111") that discharges the lubricating oil LO from the first bearing chamber 39. The first oil discharge port 111 is disposed on a lower part of the first bearing chamber 39. The first oil discharge port 111 may be disposed in any position that enables the discharge port to draw in the lubricating oil LO that is stored in the first bearing chamber 39. Therefore, the first oil discharge port 111 need not necessarily be disposed on the lowermost part of the first bearing chamber 39.

Moreover, as noted previously, an air curtain is formed in the vicinity of the first bearing 38. Therefore, a situation is suppressed in which the lubricating oil LO that is supplied to the first bearing 38 enters the accommodation chamber 24 via the annular gap 49 (refer to FIG. 4).

As shown in FIG. 3, the second distribution path 136 of the lubricating oil flow path structure 130 is formed in the main housing 20. The lubricating oil LO is supplied via the second distribution path 136 to the second bearing 40. The lubricating oil LO that is supplied to the second bearing 40 is discharged from the second bearing chamber 41 via the second drain path 114 that is formed in the rotating electric machine housing 18.

An upstream end of the second drain path 114 is an oil discharge port 115 (hereinafter referred to as a "second oil discharge port 115") that discharges the lubricating oil LO from the second bearing chamber 41. The second oil discharge port 115 is disposed on a lower part of the second bearing chamber 41. The second oil discharge port 115 may be disposed in any position that enables the discharge port to draw in the lubricating oil LO that is stored in the second bearing chamber 41. Therefore, the second oil discharge port 115 need not necessarily be disposed on the lowermost part of the second bearing chamber 41.

Moreover, as noted previously, an air curtain is formed in the vicinity of the second bearing 40. Therefore, a situation is suppressed in which the lubricating oil LO that is supplied to the second bearing 40 enters the accommodation chamber 24.

As shown in FIG. 3, the rotor cooling structure 150 is a flow path in order to supply the lubricating oil LO into the rotor 32, and thereby cool the permanent magnets 61. The rotor cooling structure 150 includes a supply path 152, the aforementioned rotor internal flow path 63, and the second drain path 114. The supply path 152 supplies the lubricating oil LO to the rotor internal flow path 63. The supply path 152 has an introduction path 152a that is formed in the first sub-housing 21, and a guide path 152b that is formed in a second oil nozzle 153.

The guide path 152b communicates with the introduction path 152a. The second oil nozzle 153 is disposed in the first bearing chamber 39. One end of the second oil nozzle 153 is fixed to the first sub-housing 21. The second oil nozzle 153 extends toward the rotor 32. A second ejection port 153a, which is an outlet of the guide path 152b, is formed in another end of the second oil nozzle 153. The second ejection port 153a, in the vicinity of the inlet 631 (refer to FIG. 4) of the rotor internal flow path 63, faces toward the inlet 631. The lubricating oil LO that is ejected from the second ejection port 153a, as shown in FIG. 4, flows via the annular opening 701 (the inlet 631) of the fastening ring 70 into the rotor internal flow path 63.

As shown in FIG. 6, the oil circulation supply device 140 is further provided in the rotating electric machine system 12. The oil circulation supply device 140, together with recovering the lubricating oil LO from the first bearing chamber 39 and the second bearing chamber 41, supplies the lubricating oil LO to the oil supply path 131 that is provided in the rotating electric machine housing 18. The oil circulation supply device 140 is equipped with a recovery pump 142, the tank 144, a supply pump 146, and a gas-liquid separator 148. By driving the recovery pump 142, the lubricating oil LO is drawn in, via the first drain path 110 and the second drain path 114, from the first bearing chamber 39 and the second bearing chamber 41. The lubricating oil LO that is drawn in flows via a recovery line 141 into the tank 144.

The tank 144 stores the lubricating oil LO that is discharged (recovered) from the first bearing chamber 39 and the second bearing chamber 41. Further, the air that is discharged from the first bearing chamber 39 and the second bearing chamber 41 is introduced into the tank 144 via the first gas discharge path 107 and the second gas discharge path 108. The air that is discharged from the first bearing chamber 39 and the second bearing chamber 41 is a gas-liquid mixture fluid that contains the lubricating oil LO in a mist like form. Therefore, the gas-liquid mixture fluid that has flowed into the tank 144 is separated into a gas and a liquid in the tank 144. More specifically, the tank 144 has a gas-liquid separation function. The air is discharged from the tank 144, and is introduced into the gas-liquid separator 148. Furthermore, after the gas-liquid separation has been completed in the gas-liquid separator 148, the air is released into the atmosphere. In the case that the oil is separated in the gas-liquid separator 148, the oil that is separated can be returned to the tank 144 or the recovery line 141.

The supply pump 146 draws in the lubricating oil LO from the tank 144, and supplies the lubricating oil LO via a supply line 149 to the oil supply path 131 of the rotating electric machine housing 18. In this manner, the oil circulation supply device 140, together with supplying the lubricating oil LO to the oil supply path 131 of the rotating electric machine housing 18, carries out an oil circulation operation to recover the lubricating oil LO from the rotating electric machine housing 18, and to supply the lubricating oil LO again to the oil supply path 131.

As shown in FIG. 1, the tank 144 comprises a tank main body 170 that is capable of carrying out gas-liquid separation. The tank main body 170 is fixed to an outer circumferential part of the rotating electric machine housing 18.

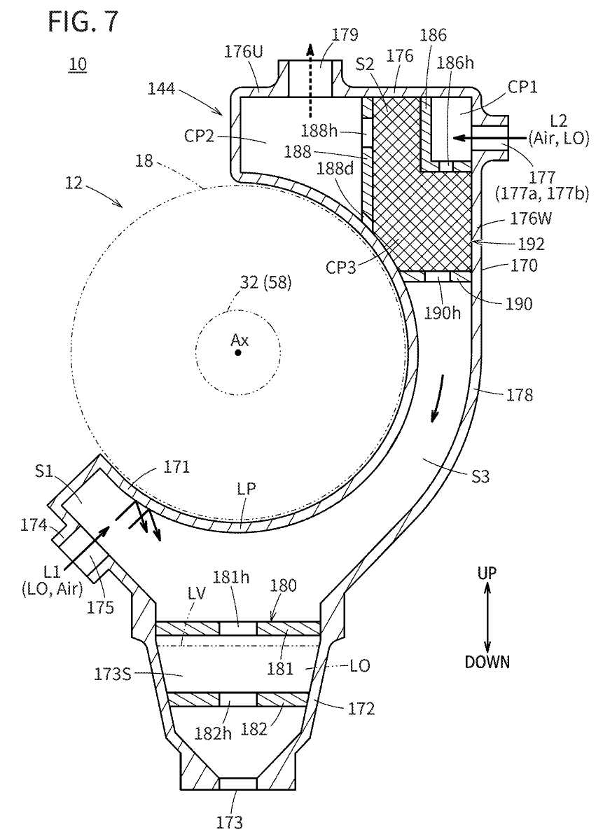

As shown in FIG. 7, the tank main body 170 is a hollow container. The tank main body 170 has a shape that extends along a circumferential direction of an outer circumferential part, in a manner so as to surround at least a portion of the outer circumferential part of the rotating electric machine housing 18. In the present embodiment, the tank main body 170 is configured in a manner so as to surround the outer circumferential part of the rotating electric machine housing 18 within a range of greater than or equal to 180 degrees taking the axis of rotation Ax as the center. The tank main body 170 comprises a storage unit 172, a first case portion 174, a second case portion 176, and a relay portion 178. The tank main body 170 may be constituted by connecting a plurality of component parts.

The storage unit 172 has in the interior thereof a storage chamber 173S that is capable of storing the lubricating oil LO. The storage unit 172 is disposed on a lower part of the tank main body 170. The storage unit 172 is positioned more downward than the axis of rotation Ax. A liquid discharge port 173 that discharges the lubricating oil LO from the storage unit 172 is disposed on a lower part of the storage unit 172. The lubricating oil LO that is discharged from the liquid discharge port 173 is supplied via the supply pump 146 to the rotating electric machine housing 18 (refer to FIG. 6).

In the present embodiment, a liquid surface adjusting structure 180 is disposed in the interior (the storage chamber 173S) of the storage unit 172. The liquid surface adjusting structure 180, in the case that the axis of rotation Ax is inclined with respect to the horizontal direction accompanying a change in the posture of the moving body on which the combined motive power system 10 (FIG. 1) is mounted, is a structure in order to suppress a large fluctuation in the liquid surface height of the lubricating oil LO that is stored in the storage unit 172 at the central position in the X direction of the tank 144, and in order to maintain the liquid surface height within a predetermined range.

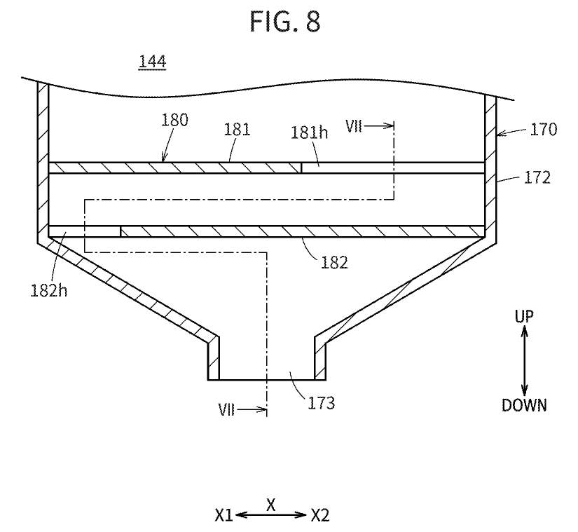

As shown in FIG. 8, the liquid surface adjusting structure 180 comprises a first baffle wall 181 and a second baffle wall 182. The first baffle wall 181 and the second baffle wall 182 are mutually spaced apart from each other in a vertical direction. The first baffle wall 181 is disposed more upward than the second baffle wall 182. The first baffle wall 181 includes a first through hole 181h that allows the lubricating oil LO to pass therethrough. The second baffle wall 182 includes a second through hole 182h that allows the lubricating oil LO to pass therethrough. In the axial direction (the X direction) of the rotating electric machine system 12, the positions of the first through hole 181h and the second through hole 182h are mutually offset from each other. Therefore, the first through hole 181h and the second through hole 182h do not face mutually toward each other in the vertical direction. Specifically, the first through hole 181h is disposed on a side in the X2 direction of the first baffle wall 181. The second through hole 182h is disposed on a side in the X1 direction of the second baffle wall 182. Moreover, in FIG. 7, the first through hole 181h and the second through hole 182h are shown at a time when viewed along the line VII-VII in FIG. 8.

As shown in FIG. 7, the first case portion 174 includes a first inlet 175. The first inlet 175 is an inlet for a first fluid L1 containing the lubricating oil LO, and is connected to the storage unit 172 (the storage chamber 173S). The first fluid L1 is a gas-liquid mixture fluid of the air and the lubricating oil LO. The first fluid L1 is a gas-liquid mixture fluid in which the ratio of the lubricating oil LO with respect to the air is large. Therefore, a major portion of the first fluid L1 is the lubricating oil LO.

The first inlet 175 is connected to the recovery line 141 (a pipe). In the interior of the first case portion 174, a first space S1 is formed into which the first fluid flows via the first inlet 175. The first case portion 174 and the first space S1 are positioned more downward than the axis of rotation Ax. The first case portion 174 and the first space S1 are positioned more upward than the storage unit 172.

The tank main body 170 comprises a wall portion 171 against which the lubricating oil LO that has flowed in from the first inlet 175 collides. The lubricating oil LO that has flowed in from the first inlet 175, after having collided against the wall portion 171, is stored in the storage unit 172. The wall portion 171 is an inner surface of the tank main body 170. The wall portion 171 is a wall that constitutes one portion of the first case portion 174. The wall portion 171 is provided in the first case portion 174 at a position facing toward the first inlet 175. In a radial direction of the rotor 32, the wall portion 171 is disposed on a more inner side than the first inlet 175. Moreover, it should be noted that the positions of the wall portion 171 and the first inlet 175 shown in FIG. 7 may be reversed, and the first inlet 175 may be disposed on a more inner side than the wall portion 171 in the radial direction of the rotor 32.

The second case portion 176 is disposed on an upper part of the tank main body 170. The second case portion 176 is positioned more upward than the axis of rotation Ax. The second case portion 176 is positioned more upward than the storage unit 172 and the first case portion 174. The second case portion 176 comprises a second inlet 177 and a gas discharge port 179.

The second inlet 177 is an inlet for a second fluid L2 containing the air and the lubricating oil LO, and is connected to the storage unit 172. The second fluid L2 is a gas-liquid mixture fluid including the air and the lubricating oil LO. The second fluid L2 is an air rich gas-liquid mixture fluid in which the ratio of the air with respect to the lubricating oil LO is large. Therefore, a major portion of the second fluid L2 is the air.

The second inlet 177 is disposed at a position that is higher than the storage unit 172 and the first inlet 175. In the interior of the second case portion 176, a second space S2 is formed into which the second fluid flows L2 via the second inlet 177. The second case portion 176 gas-liquid separates the second fluid L2 in the second space S2 into the lubricating oil LO and the air. The second case portion 176 projects out in a horizontal direction from an upper end of the relay portion 178.

The second inlet 177 is formed in a side wall 176W that extends in the up-down direction of the second case portion 176. The second inlet 177 includes two inlets 177a and 177b. As shown in FIG. 6, one inlet 177a is an opening in order to introduce the second fluid L2 which contains the air that is discharged from the first bearing 38. The other inlet 177b is an opening in order to introduce the second fluid L2 which contains the air that is discharged from the second bearing 40. Gas discharge lines 184a and 184b (pipes) are connected respectively to the inlets 177a and 177b. Moreover, the second inlet 177 may be constituted by one single opening. In this case, the two gas discharge lines 184a and 184b join together on a more upstream side than the second inlet 177, and a joining line is connected to the second inlet 177.

As shown in FIG. 7, a first partition wall 186, a second partition wall 188, a third partition wall 190, and a gas-liquid separation promoting member 192 are arranged in the interior (the second space S2) of the second case portion 176. The gas-liquid separation promoting member 192 is disposed between the first partition wall 186, the second partition wall 188, and the third partition wall 190. In the first partition wall 186, there are formed one or a plurality of first communication holes 186h in order to allow the second fluid L2 to pass therethrough. A space that is surrounded by one part of the second case portion 176 and the first partition wall 186 is a first compartment CP1. The second fluid L2 that flows in via the second inlet 177, at first, is introduced into the first compartment CP1.

In the second partition wall 188, there are formed one or a plurality of second communication holes 188h in order to allow the air to pass therethrough. A space that is surrounded by one part of the second case portion 176 and the second partition wall 188 is a second compartment CP2. The air that has passed through the second communication holes 188h flows into the second compartment CP2. A drain hole 188d is formed in a lower part of the second partition wall 188. The second communication holes 188h are formed more upward than the drain hole 188d. In the case that the lubricating oil LO has flowed into the second compartment CP2, the lubricating oil LO flows from the second compartment CP2 via the drain hole 188d, and into the third compartment CP3 in which the gas-liquid separation promoting member 192 is disposed.

In the third partition wall 190, there are formed one or a plurality of third communication holes 190h in order to allow the lubricating oil LO to pass therethrough. The lubricating oil LO that has passed through the third communication holes 190h flows toward the storage chamber 173S. The gas-liquid separation promoting member 192 is a porous structure, for example, a mesh-like member. The second fluid L2 that has flowed into the gas-liquid separation promoting member 192, by coming into contact with a non-space portion of the gas-liquid separation promoting member 192, thereby promotes the gas-liquid separation.

The gas discharge port 179 is an opening in order to discharge the air that has been gas-liquid separated from the second fluid L2. The gas discharge port 179 is disposed on an upper wall 176U of the second case portion 176. The air that is discharged from the gas discharge port 179 is released into the atmosphere via the gas-liquid separator 148 (refer to FIG. 6).

As shown in FIG. 7, the relay portion 178 connects the storage unit 172 and the second case portion 176. A relay path S3 that connects the storage chamber 173S and the second space S2 is formed inside the relay portion 178. In the present embodiment, the relay portion 178 and the relay path S3 extend in an arcuate shape along an outer circumferential part of the rotating electric machine housing 18. The lubricating oil LO, which is a liquid obtained by way of gas-liquid separation from the second fluid L2, flows via the relay path S3 into the storage chamber 173S.

The internal space of the tank main body 170 has a bifurcated shape that branches from the storage unit 172 (the storage chamber 173S) toward the first space S1 and the second space S2. Since the first case portion 174 is disposed more downward than the second case portion 176, the tank main body 170 has an asymmetrical shape with respect to a vertical line passing through the axis of rotation Ax.

Next, a description will be given concerning the gas turbine engine 14 shown in FIG. 1. Moreover, it should be noted that the configuration of the gas turbine engine 14, for example, is similar to the configuration shown in FIG. 7 of JP 2023-106078 A. Therefore, the description of the gas turbine engine 14 will be kept brief.

The gas turbine engine 14 is equipped with an engine housing 160. The engine housing 160 is connected to the rotating electric machine housing 18. The engine housing 160 includes a plurality of leg members 166. An air intake space is formed between the leg members 166.

As shown in FIG. 2, the gas turbine engine 14 is equipped with an output shaft 168. A non-illustrated compressor wheel and a non-illustrated turbine wheel are mounted in a radially outward direction of the output shaft 168. The output shaft 168 is connected to the rotating shaft 58. The compressor wheel and the turbine wheel are capable of rotating integrally together with the rotating shaft 58 and the output shaft 168.

The gas turbine engine 14 may be the gas supply device 103 that supplies the air to the gaseous coolant flow path structure 102 (the sealing air flow path structure). In this case, a portion of the air that is generated by the rotation of the compressor wheel is extracted, and is supplied to the gas supply path 104 that is disposed in the first sub-housing 21. Moreover, the gas supply device 103 may be another compressor that compresses the atmosphere and supplies the same to the gas supply path 104. The cooling gas that is supplied to the gas supply path 104 may be a gas that is supplied from an oxygen cylinder, a nitrogen cylinder, or the like.

The combined motive power system 10 that is constituted as described above operates in the following manner.

First, by driving the rotating electric machine 16, the gas turbine engine 14 is started. When the gas turbine engine 14 starts, the rotor 32 of the rotating electric machine 16 rotates due to the rotational driving force of the output shaft 168 of the gas turbine engine 14, and electricity is generated in the rotating electric machine 16. In accordance with this feature, the combined motive power system 10 is placed in operation.

As shown in FIG. 6, during the operation of the combined motive power system 10, the air is supplied from the gas supply device 103 to the rotating electric machine housing 18. The rotating electric machine 16, together with being cooled, is sealed by the air curtain. Further, the lubricating oil LO is supplied from the oil circulation supply device 140 to the oil supply path 131 of the rotating electric machine housing 18, and the lubricating oil LO is supplied to the first bearing 38 and the second bearing 40. In this case, as shown in FIG. 3, the first oil nozzle 138 ejects the lubricating oil LO toward the first bearing 38.

The lubricating oil LO is supplied from the oil circulation supply device 140 to the second oil nozzle 153, and the lubricating oil LO is ejected from the second oil nozzle 153 toward the rotor 32 (the inlet of the rotor internal flow path 63). In accordance with this feature, the permanent magnets 61 are cooled by the lubricating oil LO that flows through the rotor internal flow path 63.

In this manner, the lubricating oil LO is ejected from the first oil nozzle 138 toward the first bearing 38, and the lubricating oil LO is ejected from the second oil nozzle 153 toward the rotor 32. In this case, a portion of the lubricating oil LO is repelled by the rotor 32 and the first bearing 38 that are rotating at a high speed, and then by gravity, reaches the oil reservoir region that is disposed on a lower part of the first bearing chamber 39. The lubricating oil LO is drawn in by the first oil discharge port 111, and is discharged from the first bearing chamber 39. The lubricating oil LO that has served to lubricate the second bearing 40 in the second bearing chamber 41 is drawn in by the second oil discharge port 115, and is discharged from the second bearing chamber 41.

On the other hand, as shown in FIG. 6, the air is discharged, via the first gas discharge path 107, from the first bearing chamber 39. In this manner, the fluid inside the first bearing chamber 39 is separated into the lubricating oil LO and the air, and each of the lubricating oil LO and the air is discharged from the first bearing chamber 39. Further, the air is discharged, via the second gas discharge path 108, from the second bearing chamber 41. In this manner, the fluid inside the second bearing chamber 41 is separated into the lubricating oil LO and the air, and each of the lubricating oil LO and the air is discharged from the second bearing chamber 41. Stated otherwise, the first bearing chamber 39 and the second bearing chamber 41 function as a first gas-liquid separation unit.

In the tank 144, the air that is discharged from the first bearing chamber 39 and the second bearing chamber 41 is introduced respectively via gas discharge lines 184a and 184b, and the gas-liquid separation is carried out again. Therefore, the tank 144 functions as a second gas-liquid separation unit.

Specifically, as shown in FIG. 7, the first fluid L1, which is an oil rich gas-liquid mixture fluid, is introduced via the first inlet 175 into the first space S1 of the tank main body 170, and the second fluid L2, which is an air rich gas-liquid mixture fluid, is introduced via the second inlet 177 into the second space S2 of the tank main body 170. In this case, the first fluid L1 (the lubricating oil LO) that was introduced via the first inlet 175, after having collided against the wall portion 171 that faces toward the first inlet 175, reaches the storage unit 172 (the storage chamber 173S). More specifically, the lubricating oil LO that was introduced via the first inlet 175 does not directly hit against the liquid surface LV of the lubricating oil LO that is stored in the storage unit 172. Therefore, in accordance with the lubricating oil LO that was introduced via the first inlet 175, the lubricating oil does not hit against the liquid surface LV of the lubricating oil LO that is stored in the storage unit 172.

On the upper part of the tank main body 170, the second fluid L2 (the gas-liquid mixture fluid of the air and the lubricating oil LO) is introduced via the second inlet 177 into the second space S2. The second fluid L2 that was introduced is gas-liquid separated into the air and the lubricating oil LO in the second space S2. The lubricating oil LO that was separated flows by gravity via the relay passage S3 into the storage chamber 173S. In this case, the flow path of the lubricating oil LO from the first space S1 to the storage chamber 173S, and the flow path of the lubricating oil LO from the second space S2 to the storage chamber 173S via the relay path S3 are separate paths. Therefore, the lubricating oils LO flowing from each of the flow paths do not interfere with each other, and smoothly reach the storage chamber 173S. The lubricating oil LO that is stored in the storage chamber 173S is discharged through the liquid discharge port 173, and is supplied again to the rotating electric machine housing 18 (refer to FIG. 6).

On the other hand, the air that is separated in the second space S2 is discharged via the gas discharge port 179 from the tank main body 170 (the second space S2). As shown in FIG. 6, the air that is discharged from the tank 144 is again separated into a gas and a liquid by the gas-liquid separator 148. Therefore, the gas-liquid separator 148 functions as a third gas-liquid separation unit.

The present embodiment possesses the following advantageous effects.

As shown in FIG. 7, the tank 144 is equipped with the storage unit 172 that is capable of storing the lubricating oil LO, the first inlet 175 which is an inlet for the first fluid L1 containing the lubricating oil LO, the second inlet 177 which is an inlet for the second fluid L2 containing the lubricating oil LO, and the gas discharge port 179 that discharges the gas that was separated from the second fluid L2. In accordance with such a configuration, together with the liquid contained in the first fluid L1 that has flowed in from the first inlet 175 being capable of being stored in the storage unit 172, the liquid contained in the second fluid that has flowed in from the second inlet 177 is capable of being stored in the storage unit 172. On the other hand, the gas contained in the second fluid is discharged from the gas discharge port 179. Therefore, the gas-liquid mixture fluid that is introduced into the tank 144 is capable of being effectively separated into a gas and a liquid. In accordance with this feature, a situation is suppressed in which the gas mixes in the lubricating oil LO that is stored in the storage unit 172, and therefore, the load on auxiliary equipment such as a pump (a supply pump or the like) is reduced, and thus it is possible to contribute to the miniaturization of the auxiliary equipment.

Since the second inlet 177 is disposed at a higher position than the first inlet 175, the second fluid L2 can be more effectively separated into a gas and a liquid.

The fluid that has flowed in from the first inlet 175, after having collided against the wall portion 171, is stored in the storage unit 172. In accordance with such a configuration, since the lubricating oil LO that has flowed in from the first inlet 175 does not directly hit against the liquid surface LV of the lubricating oil LO (the stored liquid) that is stored in the storage unit 172, a situation can be suppressed in which air bubbles become mixed within the stored liquid due to hitting the liquid surface.

The wall portion 171 is an inner surface of the tank main body 170. In accordance with such a configuration, since the inner surface of the tank main body 170 itself is the wall portion 171, hitting of the liquid surface can be prevented without the addition of any special component part.

The internal space of the tank main body 170 has a shape that branches from the storage unit 172 toward the first space S1 and the second space S2. In accordance with such a configuration, the lubricating oil LO that has flowed in from the first inlet 175 can flow into the storage unit 172 without passing through the second space S2. Further, the liquid that has flowed in from the second inlet 177 and has been separated from the gas can flow into the storage unit 172 without passing through the first space S1. Therefore, it is possible to effectively carry out the gas-liquid separation.

The second case portion 176 of the tank main body 170 projects out in a horizontal direction from an upper end of the relay portion 178. In accordance with such a configuration, the gas-liquid separation function in the second space S2 can be improved.

The tank main body 170 has a shape that extends along a circumferential direction of an outer circumferential part, in a manner so as to surround at least a portion of the outer circumferential part of the rotating electric machine housing 18. In accordance with such a configuration, since the tank main body 170 has a shape that conforms to the outer circumferential part of the rotating electric machine system 12, the tank 144 can be disposed in a space-saving manner.

The storage unit 172 is positioned more downward than the axis of rotation Ax of the rotating shaft 58. The second case portion 176 is positioned more upward than the axis of rotation Ax. In accordance with such a configuration, since the second case portion 176 into which the second fluid flows L2 is provided at a height that is comparatively distanced from the storage unit 172, the gas-liquid separation function can be improved.

The first case portion 174 is positioned more downward than the axis of rotation Ax. In accordance with such a configuration, even if the first case portion 174 is arranged in a manner so as to cover the outer circumference of the rotating electric machine system 12, by suppressing the height of the first case portion 174, the tank 144 can be made more compact. Within the internal space of the first case portion 174, the space that is more upward than a lowermost part LP of the inner circumferential part of the tank main body 170 becomes a space (a dead volume) from which the air cannot escape. Unlike the present embodiment, in the case that the first case portion 174 is positioned more upward than the axis of rotation Ax, the dead volume in the interior of the first case portion 174 becomes large. On the other hand, as in the present embodiment, by positioning the first case portion 174 more downward than the axis of rotation Ax, since the space in the first case portion 174 from which the air cannot escape can be made smaller, it is possible to prevent the air from remaining in the first case portion 174, and thus it is possible to suppress a situation in which the capacity in the tank 144 becomes wasted due to trapped air.

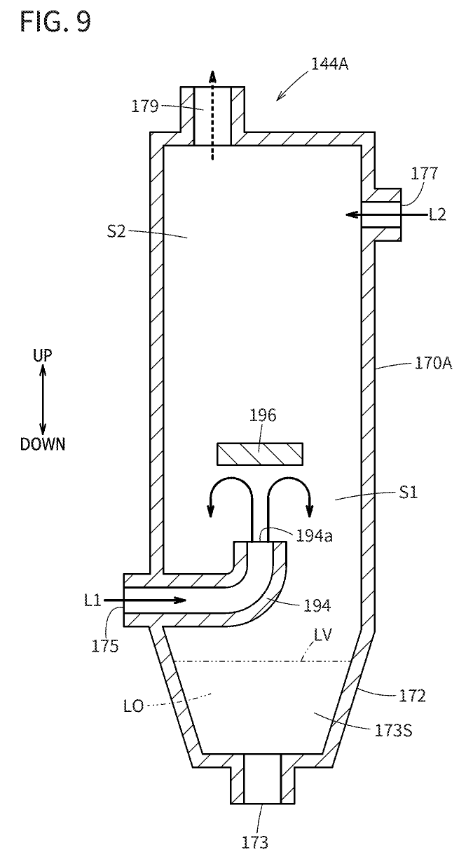

As in a tank 144A according to the exemplary modification shown in FIG. 9, the internal space of the tank main body 170A need not necessarily be bifurcated. More specifically, in this tank 144A, the storage chamber 173S in which the lubricating oil LO is stored, the first space S1 into which the first fluid L1 flows, and the second space S2 into which the second fluid L2 flows are arranged in series in the up-down direction. In this case, a nozzle 194 having an upwardly facing outlet 194a is connected to the first inlet 175. A wall portion 196 is disposed directly above the outlet 194a of the nozzle 194. The lubricating oil LO contained in the first fluid L1 that has flowed out from the outlet 194a collides against the wall portion 196, and after having bounced off downwardly therefrom, reaches the storage chamber 173S.

The second fluid L2 that has flowed in from the second inlet 177 is separated into a gas and a liquid in the upper part of the tank main body 170A. The lubricating oil LO that is separated falls downward or flows downward by gravity and reaches the storage chamber 173S. The air that is separated is discharged via the gas discharge port 179. By the tank 144A that is constituted in this manner, the gas-liquid mixture fluid that is introduced into the tank 144A is also capable of being effectively separated into a gas and a liquid.

In relation to the above-described embodiment, the following supplementary notes are further disclosed.

### Supplementary Note 1

The tank (144) of the present disclosure is the tank including the tank main body (170) configured to carry out gas-liquid separation, the tank including the storage unit (172) disposed in the tank main body, and configured to store the liquid, the first inlet (175), which is the inlet for the first fluid (L1) containing the liquid, configured to communicate with the storage unit, the second inlet (177), which is the inlet for the second fluid (L2) containing the gas and the liquid, configured to communicate with the storage unit, and disposed at a position higher than the storage unit, the liquid discharge port (173) configured to discharge the liquid from the storage unit, and the gas discharge port (179) configured to discharge the gas that was separated from the second fluid. In accordance with such a configuration, together with the liquid contained in the first fluid that has flowed in from the first inlet being capable of being stored in the storage unit, the liquid contained in the second fluid that has flowed in from the second inlet is capable of being stored in the storage unit. Further, the gas contained in the second fluid is discharged from the gas discharge port. Therefore, the gas-liquid mixture fluid that is introduced into the tank is capable of being effectively separated into a gas and a liquid.

### Supplementary Note 2

In the tank according to Supplementary Note 1, the second inlet may be disposed at a higher position than the first inlet. In accordance with such a configuration, the second fluid can be more effectively separated into the gas and the liquid.

### Supplementary Note3

In the tank according to Supplementary Note 1 or 2, there may further be provided the wall portion (171) against which the liquid that has flowed in from the first inlet collides, wherein the liquid that has flowed in from the first inlet may be stored in the storage unit after having collided against the wall portion. In accordance with such a configuration, since the liquid that has flowed in from the first inlet does not directly collide against the liquid (the stored liquid) that is stored in the storage unit, it is possible to suppress a situation in which air bubbles, due to hitting the liquid surface, become mixed into the stored liquid.

### Supplementary Note 4

In the tank according to Supplementary Note 3, the wall portion may be an inner surface of the tank main body. In accordance with such a configuration, since the inner surface of the tank main body itself is the wall portion, hitting of the liquid surface can be prevented without the addition of any special component part.

### Supplementary Note 5

In the tank according to any one of Supplementary Notes 1 to 4, the first space (S1) into which the first fluid flows via the first inlet, and the second space (S2) into which the second fluid flows via the second inlet may be provided within the tank main body, and the internal space of the tank main body may have a shape that branches from the storage unit toward the first space and the second space. In accordance with such a configuration, the liquid that has flowed in from the first inlet can flow into the storage unit without passing through the second space. Further, the liquid that has flowed in from the second inlet and has been separated from the gas can flow into the storage unit without passing through the first space. Therefore, it is possible to effectively carry out the gas-liquid separation.

### Supplementary Note 6

In the tank according to Supplementary Note 5, the tank main body may include the first case portion (174) including the first space, the second case portion (176) including the second space, and the relay portion (178) connecting the storage unit and the second case portion, and the second case portion may project out in a horizontal direction from the upper end of the relay portion. In accordance with such a configuration, the gas-liquid separation function in the second space can be improved.

### Supplementary Note 7

In the tank according to any one of Supplementary Notes 1 to 6, the tank may be an oil tank provided in the oil circulation supply device (140) which is configured to supply the lubricating oil (LO) to the bearing that is provided in the interior of a rotating electric machine housing (18) of the rotating electric machine system (12), and to recover the lubricating oil that is discharged from the rotating electric machine housing. In accordance with such a configuration, the lubricating oil can be efficiently recovered.

### Supplementary Note 8

In the tank according to Supplementary Note 7, the first space into which the first fluid flows via the first inlet, and the second space into which the second fluid flows via the second inlet may be provided within the tank main body, the internal space of the tank main body may have a shape that branches from the storage unit toward the first space and the second space, and the tank main body may have a shape that extends along the circumferential direction of the outer circumferential part of the rotating electric machine housing, in a manner so as to surround at least a portion of the outer circumferential part. In accordance with such a configuration, since the tank main body has a shape that conforms to the outer circumferential part of the rotating electric machine system, the tank can be disposed in a space-saving manner.

### Supplementary Note 9

The rotating electric machine system of the present embodiment is the rotating electric machine system, including the rotating electric machine housing configured to rotatably support the rotating shaft (58) via the bearing, the oil circulation supply device configured to supply the lubricating oil to the rotating electric machine housing in order to lubricate the bearing, and to recover the lubricating oil from the rotating electric machine housing, wherein the oil circulation supply device is equipped with the tank including the tank main body configured to carry out gas-liquid separation, the tank including the storage unit disposed in the tank main body, and configured to store the lubricating oil, the first inlet, which is the inlet for the first fluid containing the lubricating oil, configured to communicate with the storage unit, the second inlet, which is the inlet for the second fluid containing the gas and the lubricating oil, configured to communicate with the storage unit, and which is disposed at a position higher than the storage unit, the liquid discharge port configured to discharge the liquid from the storage unit, and the gas discharge port configured to discharge the gas that was separated from the second fluid. In accordance with such a configuration, the lubricating oil can be efficiently recovered.

### Supplementary Note 10

In the rotating electric machine system according to Supplementary Note 9, the first space into which the first fluid flows via the first inlet, and the second space into which the second fluid flows via the second inlet may be provided within the tank main body, the tank main body may include the first case portion including the first space, the second case portion including the second space, and the relay portion connecting the storage unit and the second space, the storage unit may be positioned more downward than the axis of rotation of the rotating shaft, and the second case section may be positioned more upward than the axis of rotation. In accordance with such a configuration, since the second case portion into which the second fluid flows is provided at a height that is comparatively distanced from the storage unit, the gas-liquid separation function can be improved.

### Supplementary Note 11

In the rotating electric machine system according to Supplementary Note 9 or 10, the first case portion may be positioned more downward than the axis of rotation. In accordance with such a configuration, the height of the first case portion can be reduced, thereby making the tank more compact. It is possible to prevent air from accumulating in the first case portion 174, and thus it is possible to suppress a situation in which there is wasted capacity of the tank 144 due to trapped air.

Although concerning the present disclosure, a detailed description thereof has been presented above, the present disclosure is not necessarily limited to the individual embodiments described above. These embodiments may be subjected to various additions, substitutions, modifications, partial deletions and the like, within a range that does not deviate from the essence and gist of the present disclosure, or the spirit of the present disclosure as derived from the content described in the claims and equivalents thereof. Further, the embodiments can also be implemented together in combination. For example, in the above-described embodiments, the order of the operations and the order of the processes are illustrated as examples, and the present invention is not necessarily limited to these features. The same also applies to cases in which numerical values or mathematical expressions are used in the description of the aforementioned embodiments.

1. A tank including a tank main body configured to carry out gas-liquid separation, the tank comprising:
a storage unit disposed in the tank main body, and configured to store a liquid;
a first inlet, which is an inlet for a first fluid containing the liquid, configured to communicate with the storage unit;
a second inlet, which is an inlet for a second fluid containing a gas and the liquid, configured to communicate with the storage unit, and disposed at a position higher than the storage unit;
a liquid discharge port configured to discharge the liquid from the storage unit; and
a gas discharge port configured to discharge the gas that was separated from the second fluid.

2. The tank according to claim 1, wherein the second inlet is disposed at a higher position than the first inlet.

3. The tank according to claim 1, further comprising a wall portion against which the liquid that has flowed in from the first inlet collides,
wherein the liquid that has flowed in from the first inlet is stored in the storage unit after having collided against the wall portion.

4. The tank according to claim 3, wherein the wall portion is an inner surface of the tank main body.

5. The tank according to claim 1, wherein a first space into which the first fluid flows via the first inlet, and a second space into which the second fluid flows via the second inlet are provided within the tank main body, and
an internal space of the tank main body has a shape that branches from the storage unit toward the first space and the second space.

6. The tank according to claim 5, wherein the tank main body comprises a first case portion including the first space, a second case portion including the second space, and a relay portion connecting the storage unit and the second case portion, and
the second case portion projects out in a horizontal direction from an upper end of the relay portion.

7. The tank according to claim 1, wherein the tank is an oil tank provided in an oil circulation supply device which is configured to supply a lubricating oil to a bearing that is provided in an interior of a rotating electric machine housing of a rotating electric machine system, and to recover the lubricating oil that is discharged from the rotating electric machine housing.

8. The tank according to claim 7, wherein a first space into which the first fluid flows via the first inlet, and a second space into which the second fluid flows via the second inlet are provided within the tank main body,
an internal space of the tank main body has a shape that branches from the storage unit toward the first space and the second space, and
the tank main body has a shape that extends along a circumferential direction of an outer circumferential part of the rotating electric machine housing, in a manner so as to surround at least a portion of the outer circumferential part.

9. A rotating electric machine system, comprising:
a rotating electric machine housing configured to rotatably support a rotating shaft via a bearing;
an oil circulation supply device configured to supply a lubricating oil to the rotating electric machine housing in order to lubricate the bearing, and to recover the lubricating oil from the rotating electric machine housing;
wherein the oil circulation supply device is equipped with a tank including a tank main body configured to carry out gas-liquid separation;
the tank comprising:
a storage unit disposed in the tank main body, and configured to store the lubricating oil;
a first inlet, which is an inlet for a first fluid containing the lubricating oil, configured to communicate with the storage unit;
a second inlet, which is an inlet for a second fluid containing a gas and the lubricating oil, configured to communicate with the storage unit, and which is disposed at a position higher than the storage unit;
a liquid discharge port configured to discharge the liquid from the storage unit; and
a gas discharge port configured to discharge the gas that was separated from the second fluid.

10. The rotating electric machine system according to claim 9, wherein a first space into which the first fluid flows via the first inlet, and a second space into which the second fluid flows via the second inlet are provided within the tank main body,
the tank main body comprises a first case portion including the first space, a second case portion including the second space, and a relay portion connecting the storage unit and the second space,
the storage unit is positioned more downward than an axis of rotation of the rotating shaft, and
the second case section is positioned more upward than the axis of rotation.

11. The rotating electric machine system according to claim 10, wherein the first case portion is positioned more downward than the axis of rotation.
